(19) United States
(12) Patent Application Publication
(10) Pub. No.: US 2013/0096246 A1
(43) Pub. Date: Apr. 18, 2013

(54) Composite Material and Related Methods

(71) Applicant: Honda Patents & Technologies North America, LL, Raymond, OH (US)

(72) Inventor: Eric Walker, Dublin, OH (US)

(73) Assignee: Honda Patents & Technologies North America, LLC, Raymond, OH (US)

(21) Appl. No.: 13/650,804

(22) Filed: Oct. 12, 2012

Related U.S. Application Data
(60) Provisional application No. 61/546,109, filed on Oct. 12, 2011.

(51) Int. Cl. C08K 3/04

(52) U.S. Cl. CPC C08K 3/04
USPC 524/496

(57) ABSTRACT

A composition having a composite material having a polymer with about 1% to about 3% by weight thin-graphite materials dispersed therein; the thin-graphite materials having diameters less than or equal to 2 microns and a surface area greater than or equal to about 300 m² per gram; and the composite material having a tensile modulus that is at least 25% greater than the unfilled polymer.

### CROSS-REFERENCE TO RELATED APPLICATIONS

This utility patent application claims priority to provisional patent application Ser. No. 61/546,109 that was filed on Oct. 12, 2011. All of the provisional-patent-application subject matter is incorporated herein by reference.

### BACKGROUND OF THE INVENTION

Although using graphite materials as fillers within a polymer is known, there remains a need for improved dispersion of thin-graphite materials within a polymer.

### BRIEF SUMMARY OF THE INVENTION

A composition having a composite material having a polymer with about 1% to about 3% by weight thin-graphite materials dispersed therein; the thin-graphite materials having diameters less than or equal to 2 microns and a surface area greater than or equal to about 300 m² per gram; and the composite material having a tensile modulus that is at least 25% greater than the unfilled polymer.

A composition having an automotive mechanical element that is made up at least in part by a composite material having a polymer with about 1% to about 3% by weight thin-graphite materials dispersed therein; the thin-graphite materials having diameters less than or equal to 2 microns and a surface area greater than or equal to about 300 m² per gram; and the composite material having a tensile modulus that is at least 25% greater than the unfilled polymer.

A method having the step of manufacturing an automotive mechanical element from a composite material having a polymer with about 1% to about 3% by weight thin-graphite materials dispersed therein; the thin-graphite materials having diameters less than or equal to 2 microns and a surface area greater than or equal to about 300 m² per gram; and the composite material having a tensile modulus that is at least 25% greater than the unfilled polymer.

A method having the step of diluting a first polymer composition with a second composition thereby resulting in a third polymer composition; wherein the first polymer composition is made up a first % by weight of thin-graphite materials; and wherein the third polymer composition is made up of less than the first % by weight of thin-graphite materials.

A method having the step of manufacturing a composite material by performing in situ polymerization of a mixture having olefin monomer and thin-graphite materials; wherein the thin-graphite materials have a surface area greater than or equal to about 300 m² per gram; and wherein the polymerized reaction product is a composite material having a polymer with about 1% to about 3% by weight thin-graphite materials dispersed therein; the thin-graphite materials having diameters less than or equal to 2 microns and a surface area greater than or equal to about 300 m² per gram; and the composite material having a tensile modulus that is at least 25% greater than the unfilled polymer.

A composition having an aircraft interior panel, a motorcycle engine cover, a motorcycle fender, an all-terrain-vehicle engine cover, an all-terrain-vehicle fender; or a power equipment engine cover that is made up at least in part by a composite material having a polymer with about 1% to about 3% by weight thin-graphite materials dispersed therein; the thin-graphite materials having diameters less than or equal to 2 microns and a surface area greater than or equal to about 300 m² per gram; and the composite material having a tensile modulus that is at least 25% greater than the unfilled polymer.

### BRIEF DESCRIPTION OF THE SEVERAL VIEWS OF THE DRAWING

FIG. 1 illustrates impact strength behavior of 10 wt % talc-PP versus 2.5 wt %-5 wt % graphite-PP.

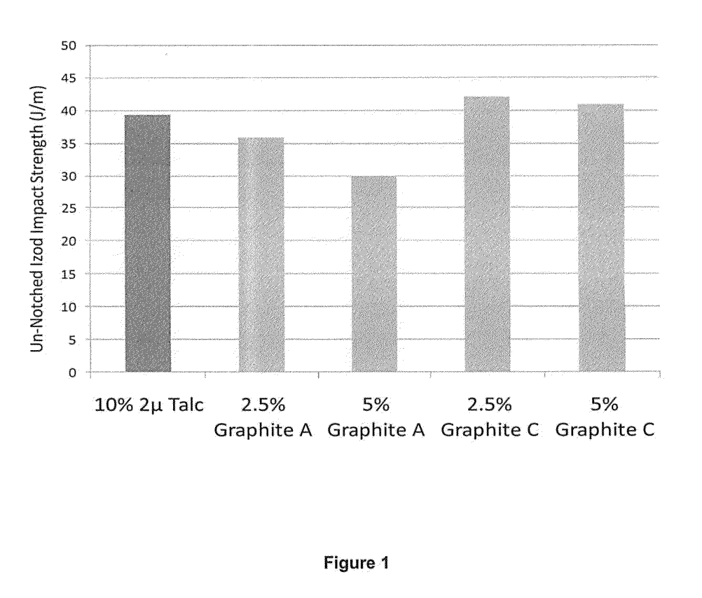

FIG. 2 illustrates viscosity behavior versus shear rate for PP copolymer, 5 wt % and 10 wt % talc-PP, and 5 wt % graphite-PP.

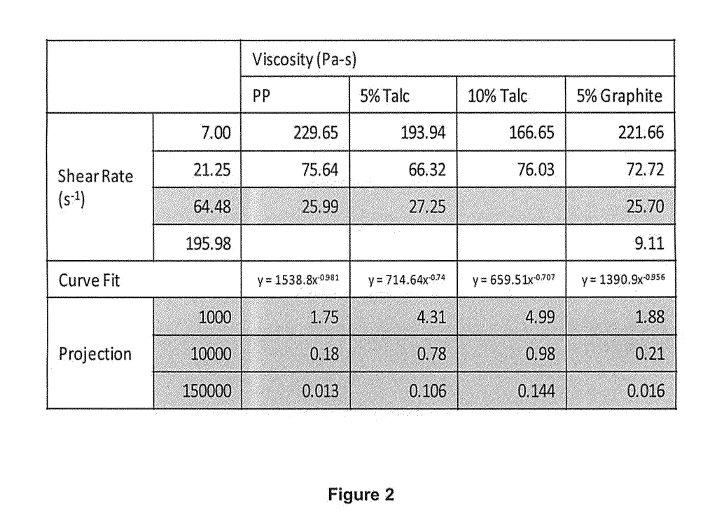

FIG. 3 illustrates tensile modulus improvement by wt % of mineral.

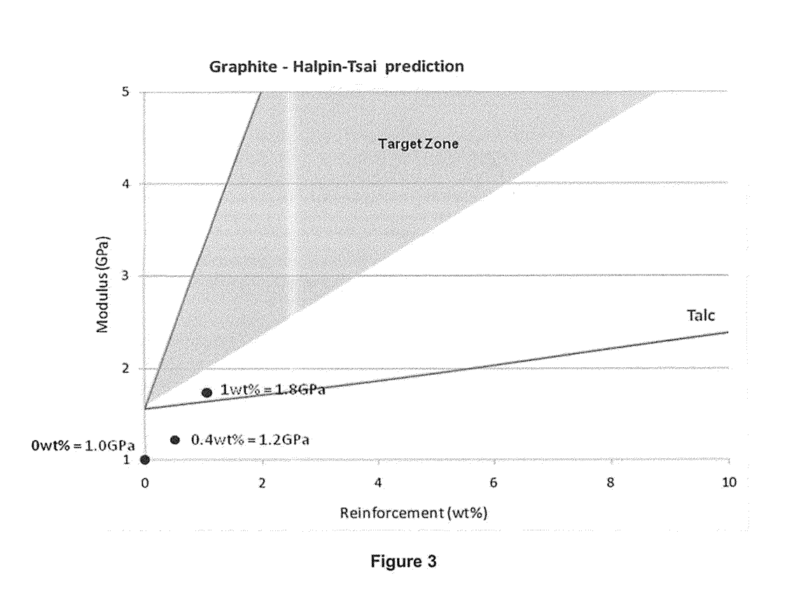

FIG. 4 illustrates tensile modulus improvement by wt % of mineral (transposing results of FIG. 3).

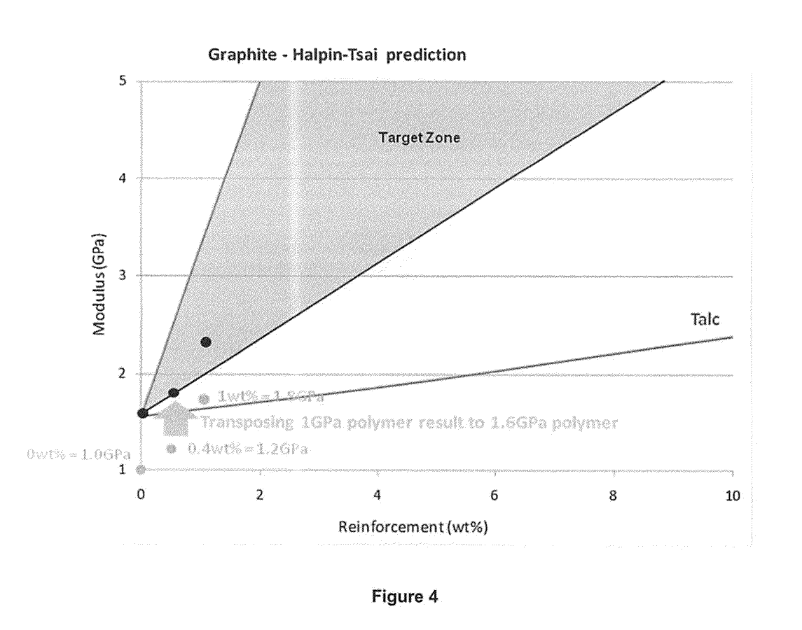

FIG. 5 illustrates normalized modulus improvement by wt % mineral through various composite manufacturing methods.

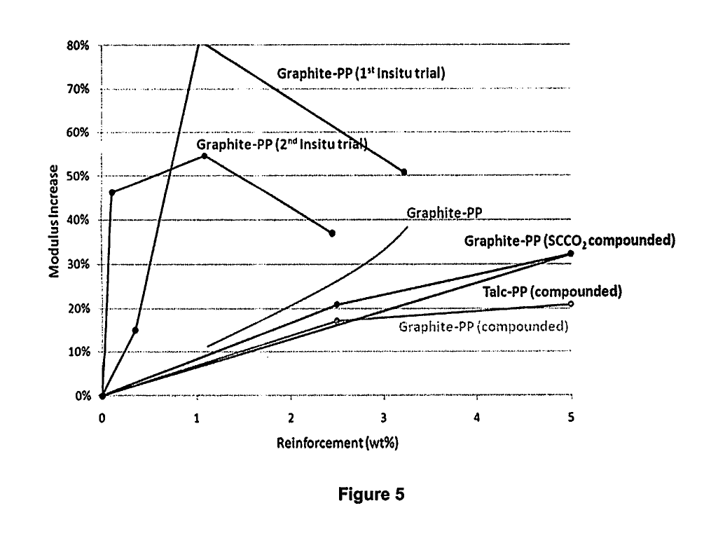

### DETAILED DESCRIPTION OF THE INVENTION

Embodiments are directed to composite materials and related methods. Composite-material embodiments are directed to thin-graphite materials disbursed within a polymer, and related embodiments are directed to the physical properties that result from both the type of thin-graphite materials dispersed within the polymer and the substantially homogenous dispersion of the thin-graphite materials within polymer. In embodiments, the dispersion of the thin-graphite materials is substantially homogenous, and the substantially homogenous dispersion results from preparing the composite material using in situ polymerization in combination with specific concentrations of thin-graphite materials having specific characteristic dimensions and properties.

Each composite-material embodiment includes two components—the first is a thin-graphite-material component and the second is a polymer component. Additional embodiments are directed to composite materials having additional components beyond the two described above. A non-limiting list of additional components includes known additives and known fillers.

Useful polymers include: polypropylene homopolymer, polypropylene copolymer, any form of polyamide (nylon 6, nylon 6/6, nylon 11, nylon 12, polymethylmethacrylate, polystyrene, polyolefin, polyethylene (including low-density (LDPE), high-density, high molecular weight (HDPE), ultra-high molecular weight (UHDPE), linear-low-density (LLDPE), very-low density, maleated polypropylene, polybutylene, polyhexalene, polyoctene, ethylene-vinyl-acetate (EVA) copolymer, copolymers, mixtures, blends and combinations thereof.

Embodiments are directed to creating a polymer matrix having thin-graphite materials dispersed therein via in situ polymerization of a monomeric solution having thin-graphite materials dispersed therein. In situ polymerization of monomeric solutions is well known, and any known method for performing in situ polymerization can be used to manufacture the composite material. In an embodiment, in situ polymerization involves metallocene catalysis in the presence of a primary and secondary catalyst, using the graphite mainly as a catalyst support but also achieving some level of solution polymerization. Ziegler-Natta catalyst(s) are also useful during in situ polymerization reactions—bulk, solution, or other. A non-limiting list of useful monomers includes: alpha-olefins (e.g., ethylene, propylene), vinyl esters, vinyl ethers, aliphatic 1,3-dienes, styrenic monomers, various forms of caprolactam, (meth)acrylate monomers (e.g., C1-C8 alkyl (meth)acrylate esters), acrylonitrile, tetrafluoroethylene, hexafluoropropylene, vinylidene difluoride, cyclosiloxanes, epoxides, [n]-metallocenophanes, and combinations thereof.

“Thin graphite” can be understood as having fewer layers than as-mined or highly milled graphite. In an embodiment, thin graphite has a diameter less than 2 μ, and a surface area greater than 300 meters per gram; “exfoliated graphite material” can be understood as having characteristic dimensions that fall within the scope of those described for “thin graphite.”

In embodiments, characteristic dimensions of useful thin-graphite materials include those having diameters less than or equal to 2 μ, less than or equal to 5 μ, and less than or equal to 10 μ. Useful thin-graphite materials also include those having aspect ratios greater than or equal to 300, greater than or equal to 400, and greater than or equal to 500; wherein the aspect ratio is defined as the ratio of diameter to thickness (the diameter being the greater of the two dimensions). Furthermore, useful thin-graphite-material embodiments include thin-graphite materials having a surface area greater than 90 m² per gram, greater than 100 m² per gram, greater than 110 m² per gram, and greater than 300 m² per gram.

In embodiments, useful amounts of thin-graphite materials within a polymer include about 1% by weight thin-graphite materials, about 2% by weight thin-graphite materials, about 3% by weight thin-graphite materials, about 1% to about 2% by weight thin-graphite materials, about 1% to about 3% by weight thin-graphite materials, and greater than about 3% by weight thin-graphite materials. “Percent by weight” is a common measurement and can be understood as: [(weight of thin-graphite materials)/(total weight of composite material)]×100%.

Embodiments are directed to composite materials having about 1% to about 3% by weight thin-graphite materials disbursed in a polymeric matrix, the composite materials having a tensile modulus that is 55-80% greater than that of the unfilled or natural polymer. In other embodiments, the tensile modulus is at least 75% greater than that of the unfilled or natural polymer. In still other embodiments, the tensile modulus is at least 50% greater than that of the unfilled or natural polymer. In still other embodiments, the tensile modulus is at least 25% greater than that of the unfilled or natural polymer. In embodiments, the composite material's tensile modulus has little or no detrimental impact on the polymer's other physical properties. In embodiments, an about 1% by weight thin-graphite filled polymer exhibits a tensile modulus that is 50% greater than the unfilled polymer. In additional embodiments, an about 1% to about 3% by weight thin-graphite filled polymer exhibits a tensile modulus that is about 25% to about 75% greater than that of the unfilled polymer.

Useful thin-graphite materials can generally be understood as very thin graphite materials, composed of fewer graphene layers than untreated natural or synthetic graphite. Exfoliated graphite materials can also be understood as a type of thin-graphite materials that have been acid intercalated, expanded, and subsequently milled. Thin-graphite materials that are described herein are well-known and commercially available. XG Sciences, Angstron, and Xolve are non-limiting examples of commercial manufacturers or distributors of thin-graphite materials.

The composite material embodiments are useful in manufacturing any known mechanical element. As a non-limiting example, the composite material can be molded into the shape of any known mechanical element using known molding techniques. Other embodiments are directed to using the composite material in combination with one or more other materials to manufacture a mechanical element such that a first part of the mechanical element is manufactured from the composite material and a second part of the mechanical element is manufactured from a different material. A mechanical element can also be manufactured using a combination of the composite material and another material.

A non-limiting list of automotive mechanical elements that can be manufactured using the composite material includes exterior bumper fascia; exterior side sill garnish; exterior rocker panel; exterior grille garnish; interior instrument panel; interior pillar garnish; interior pillar trim; interior center console; interior door trim; interior door module; engine room air cleaner case; engine room air intake tube; engine room timing belt cover; and engine room engine cover.

An additional list of non-limiting examples of mechanical elements that can be manufactured with the composite material includes an aircraft interior panel, a motorcycle engine cover, a motorcycle fender, an all-terrain-vehicle engine cover, an all-terrain-vehicle fender; or a power equipment engine cover.

Additional embodiments are directed to using a composite material as a concentrate by subsequently letting down or diluting the composite material with another polymer. Methods for letting down or diluting a concentrate with another polymer are common, and any of these common methods may be employed with the composite material. As a non-limiting example, a composite material embodiment having a first percent-by-weight concentration of thin-graphite materials can be diluted or compounded with a second material thereby creating a third composite material having a percent-by-weight concentration of thin-graphite materials that is less than the first percent-by-weight concentration of thin-graphite materials.

The above description of the present invention is provided for the purpose of illustration, and it would be understood by those skilled in the art that various changes and modifications may be made without changing technical conception and essential features of the present invention. Thus, it is clear that the above-described embodiments are illustrative in all aspects and do not limit the present invention.

What is claimed is:

1. A composition comprising:
a composite material having a polymer with about 1% to about 3% by weight thin-graphite materials dispersed therein; the thin-graphite materials having diameters less than or equal to 2 microns and a surface area greater than or equal to about 300 m² per gram; and the composite material having a tensile modulus that is at least 25% greater than the unfilled polymer.

2. The composition of claim 1, wherein the polymer is selected from the group consisting of polypropylene homopolymer, polypropylene copolymer, polyamide, nylon 6, nylon 6/6, nylon 11, nylon 12, polymethylmethacrylate, polystyrene, polyolefin, polyethylene, low-density polyethylene, high-density polyethylene, high molecular weight polyethylene, ultra-high molecular weight polyethylene, linear-low-density polyethylene, very-low density polyethylene, maleated polypropylene, polybutylene, polyhexalene, polyoctene, ethylene-vinyl-acetate copolymer, copolymers, mixtures, blends, alloys and combinations thereof.

3. The composition of claim 1, wherein the polymer is about 1% to about 2% by weight thin-graphite materials.

4. The composition of claim 1, wherein the polymer is about 1% by weight thin-graphite materials.

5. The composition of claim 1, wherein the tensile modulus is 55-80% greater than the unfilled polymer.

6. A composition comprising:
an automotive mechanical element that is made up at least in part by a composite material having a polymer with about 1% to about 3% by weight thin-graphite materials dispersed therein; the thin-graphite materials having diameters less than or equal to 2 microns and a surface area greater than or equal to about 300 m² per gram; and the composite material having a tensile modulus that is at least 25% greater than the unfilled polymer.

7. The composition of claim 6, wherein the automotive mechanical element is selected from the group consisting of exterior bumper fascia; exterior side sill garnish; exterior rocker panel; exterior grille garnish; interior Instrument panel; interior pillar garnish; interior pillar trim; interior center console; interior door trim; interior door module; engine room air cleaner case; engine room air intake tube; engine room timing belt cover; and engine room engine cover.

8. The composition of claim 6, wherein the tensile modulus is 55-80% greater than the unfilled polymer.

9. The composition of claim 6, wherein the polymer is about 1% to about 2% by weight thin-graphite materials.

10. The composition of claim 6, wherein the polymer is about 1% by weight thin-graphite materials.

11. A method comprising the step:
manufacturing an automotive mechanical element from a composite material having a polymer with about 1% to about 3% by weight thin-graphite materials dispersed therein; the thin-graphite materials having diameters less than or equal to 2 microns and a surface area greater than or equal to about 300 m² per gram; and the composite material having a tensile modulus that is at least 25% greater than the unfilled polymer.

12. The method of claim 9, wherein in the automotive mechanical element is selected from the group consisting of exterior bumper fascia; exterior side sill garnish; exterior rocker panel; exterior grille garnish; interior instrument panel; interior pillar garnish; interior pillar trim; interior center console; interior door trim; interior door module; engine room air cleaner case; engine room air intake tube; engine room timing belt cover; and engine room engine cover.

13. The method of claim 9, wherein the tensile modulus is 55-80% greater than the unfilled polymer.

14. The composition of claim 9, wherein the polymer is about 1% to about 2% by weight thin-graphite materials.

15. The composition of claim 9, wherein the polymer is about 1% by weight thin-graphite materials.

16. A method comprising the step:
diluting a first polymer composition with a second composition thereby resulting in a third polymer composition; wherein the first polymer composition is made up a first % by weight of thin-graphite materials; and wherein the third polymer composition is made up of less than the first % by weight of thin-graphite materials.

17. The method of claim 12, wherein the first percent by weight of thin-graphite materials is greater than or equal to about 5% by weight.

18. The method of claim 12, wherein the first percent by weight of thin-graphite materials is greater than about 3% by weight.

19. A method comprising the step:
manufacturing a composite material by performing in situ polymerization of a mixture having olefin monomer and thin-graphite materials; wherein the thin-graphite materials have a surface area greater than or equal to about 300 m² per gram; wherein the polymerized reaction product is a composite material having a polymer with about 1% to about 3% by weight thin-graphite materials dispersed therein; the thin-graphite materials having diameters less than or equal to 2 microns and a surface area greater than or equal to about 300 m² per gram; and the composite material having a tensile modulus that is at least 25% greater than the unfilled polymer.

20. The composition of claim 19, wherein the polymer is about 1% to about 2% by weight thin-graphite materials.

21. The composition of claim 19, wherein the polymer is about 1% by weight thin-graphite materials.

22. A composition comprising:
an aircraft interior panel, a motorcycle engine cover, a motorcycle fender, an all-terrain-vehicle engine cover, an all-terrain-vehicle fender; or a power equipment engine cover that is made up at least in part by a composite material having a polymer with about 1% to about 3% by weight thin-graphite materials dispersed therein; the thin-graphite materials having diameters less than or equal to 2 microns and a surface area greater than or equal to about 300 m² per gram; and the composite material having a tensile modulus that is at least 25% greater than the unfilled polymer.

23. The composition of claim 22, wherein the polymer is about 1% to about 2% by weight thin-graphite materials.

24. The composition of claim 22, wherein the polymer is about 1% by weight thin-graphite materials.
